(19) United States
(12) Patent Application Publication
(10) Pub. No.: US 2016/0098656 A1
(43) Pub. Date: Apr. 7, 2016

(54) Critical Path Scheduling with Primacy

(71) Applicant: Bernard Ertl, Houston, TX (US)

(72) Inventor: Bernard Ertl, Houston, TX (US)

(21) Appl. No.: 14/504,881

(22) Filed: Oct. 2, 2014

(51) Int. Cl. G06Q 10/06

(52) U.S. Cl. CPC G06Q 10/06311

(57) ABSTRACT

Systems, computer-implemented methods and non-transitory computer-readable storage medium are provided for updating a project schedule by creating task primacy relationships between tasks in projects that follow the critical path method. Creation of task primacy relationships involves the identification of a primary task and at least one related subordinate task. During the calculation of the forward pass and/or the backward pass, the working calendar of the subordinate task is amended to exclude the working time from the primary task.

### BACKGROUND

Effective project management requires the development of a realistic plan and a clear communication of the plan from the beginning to the end of the project. The critical path method of scheduling (or “CPM”) is the fundamental tool used to develop and communicate project plans. CPM scheduling calculations can be applied in any project that has a number of individual and interdependent tasks.

In order to use the CPM, a model of the project is constructed. The model includes but is not limited to a list of all activities or tasks required to complete the project, the duration or time to complete each task and the dependencies between the tasks. The CPM may involve graphically depicting or diagramming how a task is related to one or more other tasks. A critical path is defined as a sequence of activities that add up to the longest overall duration. It is the shortest time possible to complete the project. Any delay of a task on the critical path directly impacts the planned project completion date. CPM calculations involve the use of data such as the number of project resources, duration, predecessor and successor relationships, etc. as input variables to: determine the earliest and latest possible dates that each task can start and finish without impacting the duration of the project (also known as early start (ES), early finish (EF), late start (LS), late finish (LF)); determine the longest path of planned tasks to the end of the project; determine “critical” tasks on the longest path, prioritize tasks for effective management; determine the “float” (that is, the amount of time that a task can be delayed without causing a delay to subsequent tasks and the project completion date); and to shorten the planned critical path of a project. Shortening the planned critical path of a project may involve pruning critical path activities, performing more tasks in parallel, or shortening the durations of critical path tasks by adding resources (or utilizing a different method, equipment or tools to accomplish the work).

### SUMMARY

Systems, computer-implemented methods and non-transitory computer-readable storage medium are provided for updating a project schedule by creating task primacy relationships between tasks in projects that follow the critical path method. Creation of task primacy relationships involves the identification of a primary task and at least one related subordinate task. During the calculation of the forward pass and/or the backward pass, the working calendar of the subordinate task is amended to exclude the working time from the primary task.

According to one embodiment, a method for updating a project schedule includes the following steps: designating a relationship in the project schedule for inclusion in a primacy relationship, wherein the primacy relationship comprises a primary task and at least one related subordinate task; and automatically calculating, by a system running on a processing device, a forward pass for the project schedule using the designated primacy relationship. The calculation of the forward pass includes amending a working calendar of the subordinate task such that a working time from the primary task is excluded.

The project schedule can be analyzed to determine a scheduling relationship between the primary task and the subordinate task. A unique identifier may be assigned to the primary task and the secondary task. The creation of a task primacy relationship involves creating a new data element to identify the primacy relationship. The new data element may be a predetermined indicator. The predetermined indicator can be assigned to or associated with the designated task relationships to identify the primacy relationship.

The method further involves monitoring, by a system running on a processing device, a prospective scheduling collision between the primary task and the corresponding subordinate task. If a prospective scheduling collision is detected, the working calendar of the subordinate task can be amended to avoid such a collision. That is, the subordinate task can be interrupted or delayed during the working time of the primary task. If the subordinate task is scheduled during the same period of time when the primary task is scheduled to occur, the subordinate task can be interrupted or delayed to avoid being scheduled during the working time of the primary task. Accordingly, a scheduling collision is avoided. The subordinate task can be scheduled to start or resume after the working time of the primary task.

In an alternate embodiment, it may be possible to update the project schedule without any collision monitoring. In this embodiment, during the determination of the forward pass, amendments can be made to the working calendar(s) for all subordinate tasks primacy relationships (that is, every time the primary task's working time is updated as the calculation iterates) irrespective of whether a collision condition may exist or not.

The working calendar of the subordinate task can be amended for a specified time period. The working calendar of the subordinate task may be amended temporarily to exclude the period of time where the primary task is scheduled to occur. As the CPM calculation progresses, the amendment to the working calendar of the subordinate task may be reversed or finalized when no longer applicable or required.

The method further involves iteratively determining primacy relationship collisions. The iterative determination involves determining where the primary task in a primacy relationship overlaps the working time or float of its related subordinate task. At the conclusion of the iterative cycle, a temporary amendment to the working calendar of the subordinate task may be reversed or finalized.

The method further involves automatically calculating, by the processing device, a backward pass for the project schedule. Any primacy relationship calendar amendments created during the forward calculation can be ignored during the backward pass calculation. The backward pass calculation can involve the same steps as the determination or calculation of the forward pass. That is, the calculation of the backward pass may involve checking for collisions and creating temporary calendar amendments for subordinate tasks where collisions are found. All calendar amendments that are created during the backward pass calculation can be reversed or deleted at the conclusion of the backward pass calculation.

According to another embodiment, a non-transitory computer-readable storage medium is disclosed. The non-transitory computer-readable storage medium includes instructions that, when executed by a processing device, cause the processing device to perform the following operations including: providing, by a user interface module, an interface for designating a relationship in a project schedule for inclusion in a primacy relationship, wherein the primacy relationship comprises a primary task and at least one related subordinate task; and automatically calculating, by a system running on a processing device, a forward pass for the project schedule using the designated primacy relationship. The calculation of the forward pass includes amending a working calendar of the subordinate task such that a working time from the primary task is excluded. The non-transitory computer-readable storage medium can further calculate the backward pass for the project schedule.

According to another embodiment, a system for updating a project schedule is disclosed. The system includes a memory to store instructions; and a processing device, coupled to the memory, wherein the processing device is to execute the instructions to perform operations comprising: providing, by a user interface module, an interface for designating a relationship in the project schedule for inclusion in a primacy relationship, wherein the primacy relationship comprises a primary task and at least one related subordinate task; and automatically calculating, by a system running on a processing device, a forward pass for the project schedule using the designated primacy relationship. The calculation of the forward pass includes amending a working calendar of the subordinate task such that a working time from the primary task is excluded.

The aforementioned advantages of the invention, as well as additional advantages thereof, are more fully described by the detailed description of exemplary embodiments and the accompanying drawings.

### BRIEF DESCRIPTION OF THE DRAWINGS

FIG. 1 is an illustration of a block diagram of a system for updating a project schedule according to one embodiment.

FIG. 2A is a diagrammatic view according to one implementation illustrating a forward pass determination with a primacy relationship according to one embodiment.

FIG. 2B is a diagrammatic view according to one implementation illustrating a backward pass determination with a primacy relationship according to one embodiment.

FIG. 3 is a flow diagram illustrating an exemplary method for updating a project schedule by the determination of a primacy relationship.

FIGS. 4A and 4B are screen displays illustrating exemplary embodiments for a before and after user interface displaying the designation of primacy relationships according to one embodiment.

### DETAILED DESCRIPTION

In this document, the term “CPM” includes all variations of the CPM including the arrow diagramming method (or “ADM”) and the precedence diagram method (or “PDM”). Both the ADM and PDM are graphical methods of depicting the sequence of tasks in a project. PDM can be represented as a network of arrows and nodes where the nodes represent tasks and the arrows indicate dependencies between the tasks. The diagram can also depict the duration of each task and time lags between the starts and finishes of related tasks. The CPM (and its PDM variation) has been used in almost all industries, including the construction industry.

Currently, project management software applications that feature critical path (and critical chain) scheduling lack the ability to identify a task as a primary task. This can prevent a subordinate, or secondary, task from being executed unless a direct (or a scheduled) relationship (either ADM or PDM relationships) is manually established. This can result in constraining the sequencing of the subordinate task.

As an example, consider a scenario with a refinery that has a heater that is opened and a crew will clean, inspect and repair both an upper and a lower level. These various tasks are represented as follows:

### Heater

Task 1—Open top and bottom manways

### Upper Level

Task 2—Install safety equipment
Task 3—Preliminary inspection
Task 4—Grit blast clean
Task 5—Inspect
Task 6—Repair per inspection
Task 7—Remove safety equipment

### Lower Level

Task 8—Clean
Task 9—Inspect
Task 10—Repair per inspection
Task 11—Close manways

The operations in the upper and lower level are performed simultaneously, whenever possible, to minimize any downtime. However, as shown in Task 4, the cleaning process for the upper level may involve an abrasive process such as, grit blasting. During grit blasting, personnel may be disallowed in the lower level, for safety considerations, while grit blasting is occurring overhead in the upper level.

A simplified view of the scheduling relationships for this scenario might include (where the numbers refer to a task identifier):
1→2
2→3
3→4
4→5
5→6
6→7
7→11
1→8
8→9
9→10
10→11

Current critical path scheduling software does not offer a solution for such a scenario where one task (for example, Task 4) is a primary task. With current critical path scheduling software, the user of the software, such as, a planner/scheduler, is required to manually add and edit relationships from the subordinate tasks to a primary task, such as, Task 4, in order to simulate a primacy relationship. This can lead to erroneous results, for example, in computing schedule length, determining task criticality, etc., as working time and float are not properly reflected or calculated for the subordinate tasks. Since this involves manually tracking and updating the schedule at a task-by-task level, this process can become increasingly more complex and challenging as the project grows in scale and involves various interdependent tasks. Unwanted errors may be introduced into the schedule. Also, the user may have limited time for analyzing and updating the schedule. Consequently, there is a need for an invention that can resolve these issues. Accordingly, there is a need for an invention that can solve this real world scheduling problem that current project management software is unable to handle/solve.

In accordance with one or more embodiments, systems, computer-implemented methods and non-transitory computer-readable storage medium(s) are provided for updating a project schedule by automatically creating task primacy relationships in projects that follow the CPM. This can facilitate correct scheduling and management of complex, real world projects.

The creation of a task primacy relationship can facilitate a subordinate task to float freely of any pre-determined order. Therefore, a subordinate task can be scheduled before, during and/or after its corresponding primary task at any point in the project lifecycle. The creation of the primacy relationship does not impact the enforcement of a constraint that a subordinate task may not to be scheduled for work during the time that its primary task is scheduled for work. This ensures that tasks are scheduled without any superfluous free float and total float accounts for non-working time during the primary task's work window.

Referring back to the earlier scenario, according to an embodiment of the invention, Task 4 can be indicated as having a primacy relationship to Tasks 8-10 (for the lower level work). When the project schedule is calculated, the working calendar for the subordinate task(s) for each primary task can be modified, as necessary, such that the calendar for the subordinate task can include the working time of the primary task as non-working time on its calendar.

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As used in this document, the term “project” is meant to include an enterprise that involves planning and creation of one or more tasks to achieve a desired goal. Projects can be measured based upon time and/or other factors. As used in this document, the term “task” is meant to include an activity or an individual unit of work that is performed as part of an overall project. As used herein, a task may further encompass any block of time that can be scheduled (or is subject to sequencing/scheduling relationships), including, but not limited to, subdivisions of activities/tasks for individual resources. A task can be a line item in project management software. A task can have multiple resources assigned to it and each resource can maintain its own time estimate and is potentially scheduled individually. As used herein, a “resource” can include people, equipment, facilities, capital, etc. that is required for the completion of a task. As used herein, the term “primacy” is used to indicate a task that is primary, that is, the task is more important than at least one other task. It is understood, that as used herein, the term “more important” does not refer to schedule or task criticality. Instead, it refers to a special relationship (for example, necessitated by safety concerns) wherein while work proceeds on a primary task, the “less important” other tasks cannot be worked (or be in progress). The less important, or secondary task, is then a “subordinate” task to the primary task. Additionally, a primary task (unlike a critical task) can have float. In project management, the term “float” refers to an amount of time that a task in a schedule can be delayed without causing a delay to a subsequent task or to the project completion date. Unlike a primary task, a task on a critical path has zero or no float. Thus, it is evident that a primary task is not analogous to a critical task. As used in this document, the term “relationship” includes identification of the sequencing/scheduling between a primary task and a subordinate task.

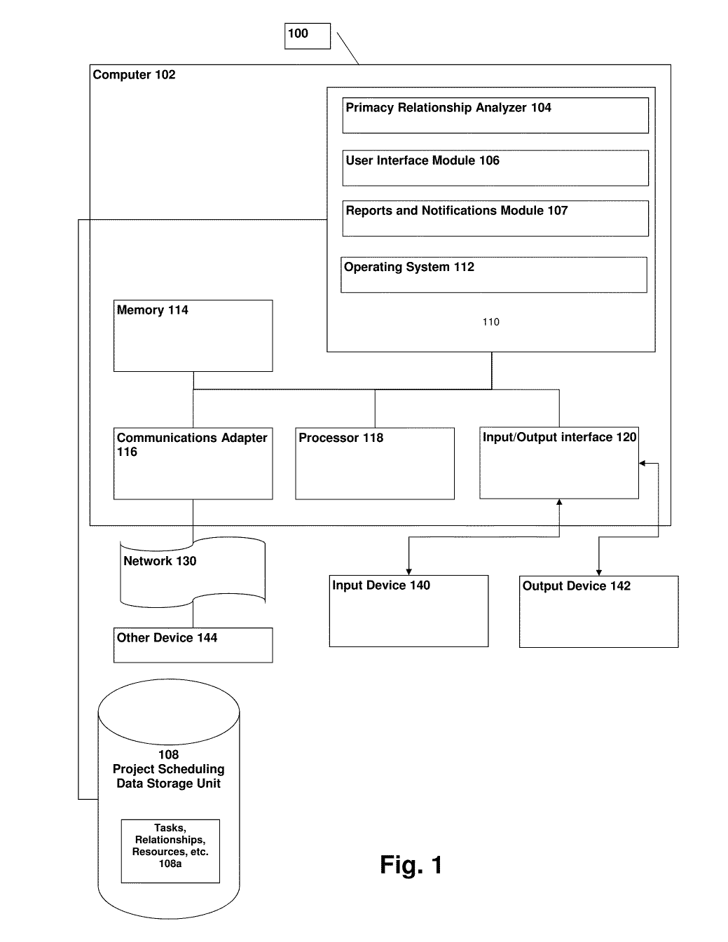

FIG. 1 illustrates a system for updating a project schedule 100 according to an embodiment of the present disclosure. The system 100 can include a multitude of interrelated elements. Embodiments of the system 100 can be implemented to some extent as software modules installed and running on one or more data processing systems (‘computer’), such as servers, workstations, tablet computers, PCs, personal digital assistants (‘PDAs’), smart phones, and so on. Computer 102 may include at least one computer processor 118 as well as a computer memory 114. Processor 118 can represent one or more general-purpose processing devices such as a microprocessor, central processing unit, or the like. More particularly, the processor 118 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 118 may also be one or more special-purpose processing devices such as an application specific integrated circuit (ASIC), a field programmable gate array (FPGA), a digital signal processor (DSP), network processor, or the like. The processor 118 can be configured to execute instructions for performing the operations and steps discussed herein. Computer memory 114 may include both volatile random access memory (‘RAM’) and some form or forms of non-volatile computer memory such as a hard disk drive, an optical disk drive, or an electrically erasable programmable read-only memory space (also known as ‘EEPROM’ or ‘Flash’ memory).

The computer memory 114 can be connected through a system bus 150 to the processor 118 and to other system components. Computer 102 may also include one or more input/output network interface device 120. Input/output interface device 120 may implement user-oriented input/output through software drivers and computer hardware for controlling output to output devices 142 such as computer display screens, as well as user input from input devices 140, such as keyboards and mice.

The system 100 may be connected to a project scheduling data storage unit 108. The project scheduling data storage unit 108 can be a local storage unit or a remote storage unit. The project scheduling data storage unit 108 may be a magnetic storage unit, optical storage unit, solid state storage unit or similar storage unit. The project scheduling data storage unit 108 can be a monolithic device or a distributed set of devices. The project scheduling data 108a can be stored in a database, file system or similar data storage system. Project scheduling data 108a may include information or data on the tasks in the project, the relationship(s) between the tasks, the resources required to complete the tasks, the duration of each task, the deadlines associated with the tasks and/or other pertinent data.

The system 100 can also include a computer readable medium 110 on which is stored an appropriate operating system 112. One or more sets of instructions (e.g., software) embodying any one or more of the methodologies or functions described herein may also be stored on the computer-readable storage medium 110. The instructions may also reside, completely or at least partially, within the memory 114 and/or within the processor 118 during execution thereof by the computer 102, the memory 114 and the processor 118 also constituting computer-readable storage media. The instructions may further be transmitted or received over a network 130.

Computer 102 can also include a communications adapter 116 for implementing data communications with other devices 144. Communications adapter 116 implements the hardware level of data communications through which one computer sends data communications to another computer through a network. The computer 102 can be accessible to any number of other devices, user machines and users 144 through a network 130. The other devices 144 can be any type of computing device including desktop computers, laptop computers, handheld computers or similar computing device. The network 130 can be local area network (LAN), such as an intranet within a company, a wide area network (WAN), such as the Internet or similar communication system. The network 130 can include any number of networking and computing devices including any number of wired and wireless devices. The network 130 may include connections, such as wire, wireless communication links, or fiber optic cables.

Any combination of one or more computer readable media 110 may be utilized. The computer readable medium 110 may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Instructions or program code embodied on the computer readable medium 110 may be transmitted using any appropriate medium, including but not limited to wireless, wireline, optical fiber cable, RF, etc., or any suitable combination of the foregoing. Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

In one embodiment, the program code can include instructions for a primacy relationship analyzer 104, a user interface module 106, and a reports and notification module 107 and or a software library containing methods that call such modules. This division of functionality is presented merely by way of example for the sake of clarity. One skilled in the art would understand that the functionality described could be combined into a monolithic component or sub-divided into any similar combination of components. In certain embodiments, the primacy relationship analyzer 104, the user interface module 106, and the reports and notification module 107 may be implemented on a separate server.

While the computer-readable storage medium 110 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

The primacy relationship analyzer 104, the user interface module 106, and the reports and notification module 107 may be implemented as one or more sub-modules operating in separate software layers or in the same layer. Although depicted separately from the operating system 112, these or one or more sub-modules may be incorporated as part of the operating system 112. In some embodiments, the primacy relationship analyzer 104 may be implemented in a project server, in the software stack, in hardware, in firmware (such as in the BIOS), or in any other manner as will occur to those of ordinary skill in the art.

The primacy relationship analyzer 104 can continually and automatically retrieve and analyze the project scheduling data 108a, in a real time basis, or in a substantially real time basis, to process a (task) primacy relationship. The project scheduling data may be analyzed to determine a scheduling relationship between a primary task and a related subordinate task. The creation of a task primacy relationship may involve the creation of a predetermined new data element to identify at least one task as a primary task for a specific subordinate task. A relationship in the project schedule is designated for inclusion in a primacy relationship by assigning the predetermined new data element or indicator to identify the primacy relationship. The subordinate task is secondary to the task identified as the primary task. The primary tasks and the subordinate tasks can be associated with a unique identifier. Although the exemplary embodiments herein refer to “a” task primacy relationship, the embodiments of the invention are applicable and are meant to encompass a plurality of primacy relationships. Furthermore, each primacy relationship may involve a primary task and one or more related subordinate tasks.

The primacy relationship analyzer 104 can further calculate a forward pass and a backward pass for schedule. During the calculation of the forward pass and/or the backward pass, the primacy relationship analyzer 104 can amend or modify the working calendar of the subordinate task to exclude a window of time when the primary task is scheduled. The subordinate task can be interrupted or delayed during the working time of the primary task. Upon the condition that the subordinate task is scheduled during the same period of time when the primary task is schedule to occur, the subordinate task can be interrupted or delayed to avoid being scheduled during the working time of the primary task. Accordingly, a scheduling collision is avoided. The subordinate task can be scheduled to start or resume after the working time of the primary task.

The user interface module 106 can interface with any of the other modules or components of the computer 102 including the primacy relationship generation module 104 and the reports and notification module 107 to generate a project scheduling interface to be utilized by a user, such as, a project planner or project manager. The user interface module 106 can provide a graphical user interface or command line interface for remote other devices 144 over the network 130. Any number of other devices 144 may be used to access the user interface module 106. The user interface module 106 can be a web-based interface such as a web server or similar specialized interface to interact with the client on remote machines.

The user interface provided by the user interface module 106 can be accessed by general purpose browsers or specialized applications. The user interface module 106 interfaces the computer 102 with the other devices 144 by making available the functionality of the primacy relationship analyzer 104 and the reports and notification module 107.

The reports and notifications module 107 interfaces with the primacy relationship analyzer 104. Reports, alerts and notifications can be generated to inform one of more users of the updated schedule. The reports may be in the form of Gantt charts that display the primacy and normal relationships. These notifications can be displayed in a report upon user request (using the user interface module 106. These notifications can also be in the form of automatic notices that get sent in the form of an email, alert, and/or logged to a database for further review by one or more users.

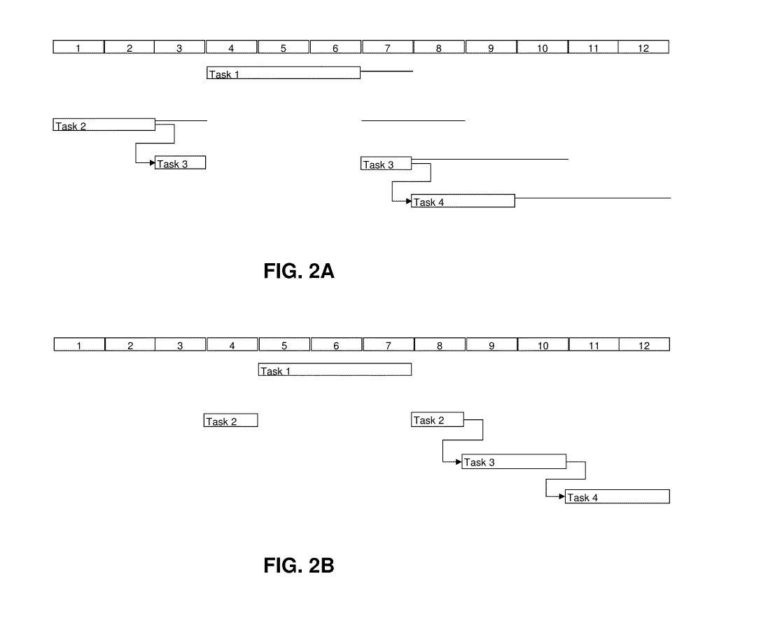

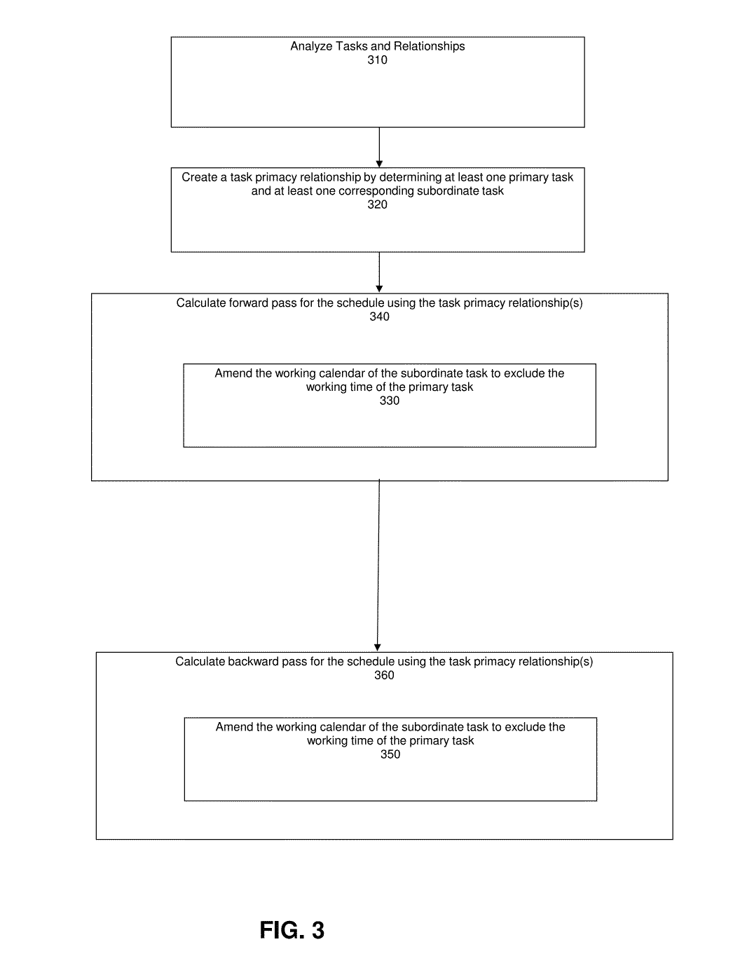

FIG. 2A represents a diagrammatic view of a forward pass determination with a creation of a primacy relationship, according to an embodiment of the invention. During the determination of the forward pass for the project schedule (to determine the early start date or times and early finish dates or times for each task), whenever processing a relationship with a task primacy, the working calendars of all subordinate tasks, and/or the resource(s) for the subordinate tasks, can be temporarily modified such that the working time of the primacy task is considered as non-working time. In project management software, a calendar can be assigned directly to the tasks or indirectly via the task's resources. The non-working time may be indicated, for example, as a holiday or an exception.

As shown in FIG. 2A, Task 1 can be designated as a primary task for subordinate tasks, Task 2, 3 and 4. During the determination of the forward pass, an initial collision or overlap is detected between primary task, Task 1 and subordinate task, Task 3. Accordingly, the calendar for subordinate task, Task 3, or its resources, may be amended or modified to exclude the working time of primary task, Task 1. The initial collision(s) during the forward pass determination may be recorded for post-processing.

FIG. 2B represents a diagrammatic view of a backward pass determination with a creation of a primacy relationship, according to an embodiment of the invention. When determining the backwards pass (to determine the late start date or times or the late finish date or times), an initial collision/overlap is detected between primary task, Task 1 and subordinate task, Task 2. Accordingly, the calendar for subordinate task, Task 2, an/or its resources, may be temporarily amended or modified to exclude the working time of primary task, Task 1. The initial collision during the backward pass determination may be recorded for post-processing.

The determination of the forward and backward passes is an iterative process. The initial amendments, during the determination of the forward and backward passes, may be temporary or for a specific time period. At the end of the specified time period, the amendment can be undone. Alternately, after both (forward and backward) passes, where the first and second collisions were recorded, that is, where the early start of primary task, Task 1 is later than the early finish of subordinate task, Task 3 and when the late finish of primary task, Task 1 is earlier than the late start of subordinate task, Task 2, the calendars for subordinate tasks, Task 3 and Task 2, or their resources, can be “permanently” modified to exclude the working time of primary task, Task 1, that is, it uses the time from the early start of Task 1 to its early finish. The term “permanently,” in the context of this document, can mean until the schedule is changed or updated, requiring a new CPM calculation.

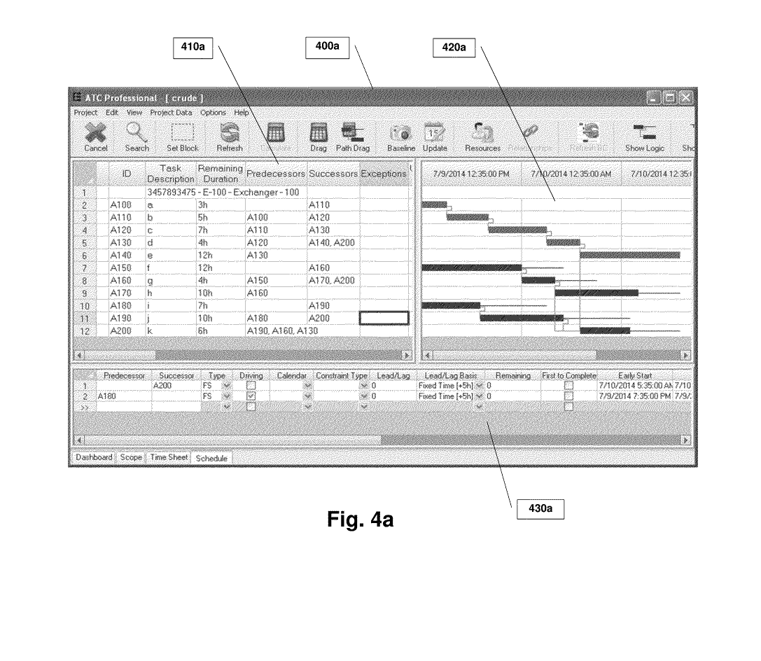

FIG. 3 is a flowchart outlining an example operation for automatically updating a schedule with a task primacy relationship, in accordance with one illustrative embodiment. Although not shown in FIG. 3, the operation can start with a request being received to generate an updated schedule. This request may be generated in response to a user input requesting an updated schedule, or it may be automatically generated in response to a detected change in the status of one or more tasks, relationships or other project data (elements). Irrespective of the origin of the request, in response to receiving this request, information on tasks and their relationships may be retrieved and analyzed 310. Other pertinent information such as resources, deadlines, etc. are also retrieved and analyzed. As described with reference to the system in FIG. 1, this project scheduling data or information may be retrieved from a project scheduling database.

As shown in step 320, the method further involves creating a task primacy relationship by determining at least one primary task and at least one corresponding subordinate task. The creation of a task primacy relationship may involve the creation of a predetermined indicator to identify the primacy relationship. The primacy relationship may be designated by assigning or associating the predetermined indicator with the at least one primary task and at least one corresponding subordinate task. The predetermined indicator may be a number, an alphabet, an alphanumeric character, or any predetermined symbol or character or combinations thereof.

The determination of at least one primary task and at least one secondary task may further involve the identification of a primary task and its corresponding subordinate task(s). The primary task and subordinate task(s) may be assigned a unique identifier. The unique identifier may be a number, an alphabet, an alphanumeric character, or any predetermined symbol or character or combinations thereof.

After the primacy relationships are identified, a forward pass for the schedule can be calculated or determined using the designated primacy relationship 340. The forward pass may be automatically calculated by a system, which executes on a processor, including a primacy relationship generator. The primacy relationship generator can apply a pre-programmed algorithm or rule to modify the working calendar of the subordinate task(s), while determining the forward pass, such that the subordinate task(s) may not be scheduled during the time that the corresponding primary task is scheduled for work 330.

The calculation of the forward pass 340 can involve monitoring the project schedule to detect a prospective scheduling collision between the primary task and the corresponding or related subordinate task. If a prospective scheduling collision is detected, the working calendar of the subordinate task can be automatically amended to avoid such a collision. If the subordinate task is scheduled during the same period of time when the primary task is scheduled to occur, the subordinate task can be interrupted or delayed to avoid being scheduled during the working time of the primary task. Accordingly, a scheduling collision is avoided. The subordinate task can be scheduled to start or resume after the working time of the primary task.

The working calendar of the subordinate task can be amended for a specified time period. The working calendar of the subordinate task may further be amended temporarily to exclude the period of time where the primary task is scheduled to occur. As the calculation progresses, the temporary amendment to the working calendar of the subordinate task may be reversed or finalized.

The calculation of the forward pass 340 further involves iteratively determining primacy relationship collisions. The iterative determination involves determining where the primary task in a primacy relationship overlaps the working time or float of its related subordinate task. At the conclusion of the iterative cycle, a temporary amendment to the working calendar of the subordinate task may be reversed or finalized.

The method further involves automatically calculating, by the processing device, a backward pass for the project schedule using the task primacy relationships 360. Any primacy relationship calendar amendments created during the forward calculation can be ignored during the backward pass calculation. The backward pass calculation 360 can involve the same steps as the determination or calculation of the forward pass. Thus, the calculation of the backward pass 360 may involve checking for collisions and creating temporary calendar amendments for subordinate tasks where collisions are found. The primacy relationship generator can apply a pre-programmed algorithm or rule to modify the working calendar of the subordinate task(s), while determining the backward pass, such that the subordinate task(s) may not be scheduled during the time that the corresponding primary task is scheduled for work 350. All calendar amendments that are created during the backward pass calculation 360 can be reversed or deleted at the conclusion of the backward pass calculation.

In another embodiment, after the primacy relationships are identified, the system automatically applies a pre-programmed algorithm or rule to modify the working calendar of the subordinate task(s) while calculating the forward pass only. The system may not check or adjust for collisions during a determination of the backward pass. Accordingly, any collisions that are detected, and subsequent adjustments made on the forward pass, may be maintained during the determination of the backward pass. This may calculate float (that is, late starts and late finishes) for subordinate tasks under the assumption that the primary task is not delayed.

The term “algorithm” can encompass an algorithm or a rule set. Alternately, it may be possible to implement one or more embodiments of the invention as distributed/event driven process. For example, it may be possible to implement one or more embodiments of the invention using stored procedures or triggers in a database as opposed to a dedicated computational process.

Although not shown, information on the primacy relationship may be displayed to an authorized user for approval and/or editing. The primacy relationship may be stored in a storage unit/database for later retrieval and use when updating or reporting the schedule. The embodiments of the invention provide an efficient method for scheduling a project.

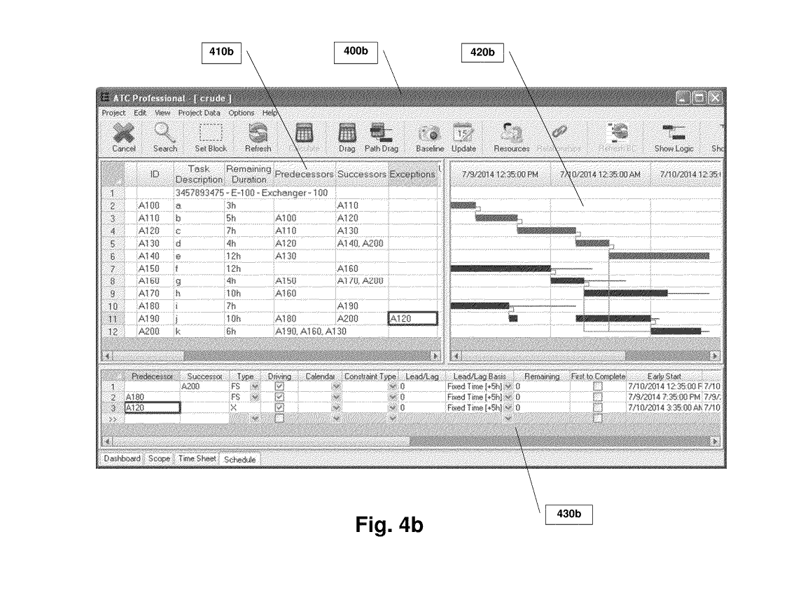

FIGS. 4A and 4B depict exemplary screen displays 400a, 400b. The user can define various tasks in an editing grid 410a, 410b shown in the top left pane. In these examples, Record/line 1 can include a summary or header. Records/lines 2-10 can include tasks with generic descriptions, shown here using identifiers a,b,c,d,e etc. Each task can be assigned a unique identifier (“ID”). Each task is further associated with a specific duration. Furthermore, each of the tasks may be associated with predecessor and/or successor tasks (for example, a list of unique identifiers for each task).

Primacy relationships can be designated on the bottom pane 430a, 430b. As shown, relationships attached to the task highlighted in the editing grid 410, for example, Task 11, can be designated. The bottom pane 430a, 430b allows the user to edit details for each relationship. As shown in FIG. 4B, the user can identify a relationship as being part of one or more primacy relationships by associating a task identifier with the designated task in the “Exceptions” column.

As shown, FIG. 4A shows an image of a basic schedule that does not have any task primacy relationships. FIG. 4B shows the same schedule as the before image, but after creating a task primacy relationship (“Exception”) between the task with the unique identifier (“ID”) of A120 and A190. In this case, Task A120 is the primary task and Task A190 is the subordinate task. As shown in bottom pane 430b, the task primacy relationship can be also highlighted/listed in the bottom pane as a special relationship (for example, “Type” X for Exception) for Task A190. Alternately, a checkbox (or, alternately, yes/no selection boxes/radio buttons, etc.) can be used to identify the primacy relationship(s) attribute(s).

A graphic representation of the schedule can be displayed in the top right pane 420a, 420b. For example, a Gantt chart format can be used to display the schedule. As shown, primacy and normal relationships can be displayed by solid lines. The primacy status of relationships could also be highlighted using color coding, different line thicknesses, symbols or other means. As can be seen in FIG. 4B, in the Gantt chart representation of the schedule 420b, the working calendar for task A190 can now exclude the window of time where task A120 is scheduled. Task A190 can start before task A120 starts. It can stop when A120 starts, and then resume after A120 finishes.

Advantageously, a unique coding or coloring schema can be used to identify the primacy relationship (for example, in a white background). Alternately, in order to identify the primacy relationship, the color of the blank (or skipped) space for Task A190 can be changed and reference or label to Task A120 can be inserted in that space.

Unless specifically stated otherwise as apparent from the above discussion, it is appreciated that throughout the description, discussions utilizing terms such as “determining,” “assigning,” “associating,” “analyzing,” “displaying,” “presenting,” or the like, refer to the actions and processes of a computer system, or similar electronic computing device that manipulates and transforms data represented as physical (electronic) quantities within the computer system's registers and memories into other data similarly represented as physical quantities within the computer system memories, registers or other such information storage, transmission or display devices.

No limitation with regard to the described aspects or embodiments of the present invention is intended. Many modifications to the depicted embodiments may be made without departing from the spirit and scope of the present invention. For example, it may be possible to only consider the primacy relationship during the calculation of the forward pass while ignoring the primacy relationship and using a different heuristic for determining the backward pass. Accordingly, the foregoing description is intended to be illustrative rather than restrictive. The invention described hereinabove is defined by the appended claims and all changes to the invention that fall within the meaning and the range of equivalency of the claims are embraced within their scope.

While the system, computer readable storage medium and methods are described in terms of “comprising,” “containing,” or “including” various components or steps, the system, computer readable storage medium and methods also can “consist essentially of” or “consist of” the various components and steps. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

1. A method for updating a project schedule, the method comprising:
designating a relationship in the project schedule for inclusion in a primacy relationship, wherein the primacy relationship comprises a primary task and at least one related subordinate task; and
automatically calculating, by a system running on a processing device, a forward pass for the project schedule using the designated primacy relationship,
wherein the calculation of the forward pass comprises amending a working calendar of the subordinate task such that a working time period from the primary task is excluded.

2. The method according to claim 1, further comprising analyzing the project schedule to determine a scheduling relationship between the primary task and the subordinate task.

3. The method according to claim 1, further comprising assigning a unique identifier to each of the primary task and the secondary task.

4. The method according to claim 1, wherein the designating the relationship for inclusion in a primacy relationship further comprises assigning a predetermined indicator to identify the primacy relationship.

5. The method according to claim 1, further comprising detecting, by a system running on a processing device, a prospective scheduling collision between the primary task and the related subordinate task.

6. The method according to claim 5, wherein the working calendar of the subordinate task is amended to exclude the working time period of the primary task to avoid the prospective scheduling collision.

7. The method according to claim 6, wherein the amendment to the working calendar of the subordinate tasks are reversed or deleted when no longer required or applicable.

8. The method according to claim 1, further comprising automatically calculating, by the system running on a processing device, a backward pass for the project schedule based on the designated primacy relationship.

9. The method according to claim 8, wherein the calculation of the backward pass comprises amending the working calendar of the subordinate task such that the working time from the primary task is excluded.

10. A non-transitory computer-readable storage medium including instructions that, when executed by a processing device, cause the processing device to perform a set of operations comprising:
providing, by a user interface module, an interface for designating a relationship in a project schedule for inclusion in a primacy relationship, wherein the primacy relationship comprises a primary task and at least one related subordinate task; and
automatically calculating, by a system running on a processing device, a forward pass for the project schedule using the designated primacy relationship,
wherein the calculation of the forward pass comprises amending a working calendar of the subordinate task such that a working time from the primary task is excluded.

11. The non-transitory computer-readable storage medium according to claim 11, further comprising instructions for assigning a predetermined indicator to identify the primacy relationship.

12. The non-transitory computer-readable storage medium according to claim 11, further comprising instructions for detecting, by the processing device, a prospective scheduling collision between the primary task and the related subordinate task.

13. The non-transitory computer-readable storage medium according to claim 12, wherein the working calendar of the subordinate task is amended to avoid the prospective scheduling collision.

14. The non-transitory computer-readable storage medium according to claim 11, further comprising instructions for reversing or deleting, when no longer required or applicable, the amendment to the working calendar of the subordinate tasks.

15. The non-transitory computer-readable storage medium according to claim 11, further comprising instructions for automatically calculating, by the system running on a processing device, a backward pass for the project schedule based on the designated primacy relationship.

16. A system for updating a project schedule comprising:
a memory to store instructions; and
a processing device, coupled to the memory, wherein the processing device is to execute the instructions to perform operations comprising:
providing, by a user interface module, an interface for designating a relationship in the project schedule for inclusion in a primacy relationship, wherein the primacy relationship comprises a primary task and at least one related subordinate task; and
automatically calculating, by a system running on a processing device, a forward pass for the project schedule based on the designated primacy relationship,
wherein the calculation of the forward pass comprises amending a working calendar of the subordinate task such that a working time from the primary task is excluded thereby avoiding the scheduling collision.

17. The system according to claim 16, further comprising instructions for assigning a predetermined indicator to identify the primacy relationship.

18. The system according to claim 16, further comprising instructions for detecting, by the system running on a processing device, a prospective scheduling collision between the primary task and the related subordinate task.

19. The system according to claim 16, further comprising instructions for automatically calculating, by the system running on a processing device, a backward pass for the project schedule based on the designated primacy relationship.

20. The system according to claim 19, wherein the calculation of the backward pass comprises amending the working calendar of the subordinate task such that the working time from the primary task is excluded.
